(19) United States
(12) Patent Application Publication
(10) Pub. No.: US 2026/0147584 A1
(43) Pub. Date: May 28, 2026

(54) INFORMATION PROCESSING APPARATUS, CONTROL METHOD OF THE APPARATUS, AND STORAGE MEDIUM

(71) Applicant: CANON KABUSHIKI KAISHA, Tokyo (JP)

(72) Inventor: YURI UEDA, Tokyo (JP)

(21) Appl. No.: 19/394,681

(22) Filed: Nov. 19, 2025

(30) Foreign Application Priority Data
Nov. 26, 2024 (JP) 2024-205845

(51) Int. Cl. G06F 9/445; G06F 8/61

(52) U.S. Cl. CPC G06F 9/445; G06F 8/61

(57) ABSTRACT

A storage medium stores programs including a first application program and a second application program. The first application program causes a computer of an information processing apparatus to perform accepting an operation for starting the second application program, acquiring first information indicating whether the second application program is downloaded in the information processing apparatus and second information indicating a state of the second application program, and displaying information concerning the second application program. When the operation for starting the second application program is accepted, the displaying displays the information concerning the second application program based on at least one of the first information and the second information.

### BACKGROUND

### Field of the Technology

The disclosure relates to an information processing apparatus, a control method of the information processing apparatus, and a storage medium.

### Description of the Related Art

A technique to collaboratively operate multiple application programs is known in recent years. For example, a mode is known in which, when a print instruction is issued in an editing application program (hereinafter referred to as an editing application) that edits content, such as document data or image data, a printing application program (hereinafter referred to as a printing application) causes an image processing apparatus to perform a certain process (for example, a printing process).

Japanese U.S. Pat. No. 7,230,467 proposes a support program that causes an information processing apparatus to perform an operation concerning download or installation of an installer depending on the installation status of a printer driver when the print instruction is issued in the editing application.

Improvement of usability is required in collaborative operation of multiple application programs.

### SUMMARY

According to an aspect of the present disclosure, there is provided a storage

medium storing programs including a first application program and a second application program. The first application program causes a computer of an information processing apparatus to perform accepting an operation for starting the second application program, acquiring first information indicating whether the second application program is downloaded in the information processing apparatus and second information indicating a state of the second application program, and displaying information concerning the second application program. When the operation for starting the second application program is accepted, the displaying displays the information concerning the second application program based on at least one of the first information and the second information.

Features of the present disclosure will become apparent from the following description of embodiments with reference to the attached drawings. The following description of embodiments is described by way of example.

### BRIEF DESCRIPTION OF THE DRAWINGS

FIG. 1 illustrates the configuration of a print processing system according to a

first embodiment.

FIG. 2 illustrates the hardware configuration of a terminal device of the first embodiment.

FIG. 3 is a block diagram illustrating the functional configuration of the terminal device and a Web server device in the first embodiment.

FIG. 4 illustrates an example of an editing screen of an editing application.

FIG. 5 illustrates an example of a print preview screen of a printing application.

FIG. 6 is a flowchart when the printing application is started from the editing application.

FIG. 7A and FIG. 7B illustrate examples of dialogues that are displayed.

FIG. 8A and FIG. 8B are sequence diagrams concerning setting of an installation flag.

FIG. 9 is a block diagram illustrating the functional configuration of the terminal device and the Web server device in a second embodiment.

FIG. 10 is a flowchart when the printing application is started from the editing application in the second embodiment.

### DESCRIPTION OF THE EMBODIMENTS

The disclosure will herein be described in detail with reference to the drawings.

Embodiments described below are not intended to limit the disclosure within the scope of the claims and all the combinations of features described in the embodiments are not necessarily essential to the resolution of the disclosure. The same reference numerals are used in the accompanying drawing to identify the same components or similar component and duplicated description of such components is omitted herein.

### First Embodiment

### System Configuration

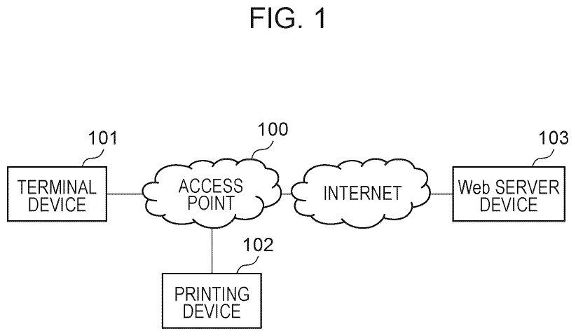

FIG. 1 illustrates an example of the configuration of a print processing system according to a first embodiment. The print processing system includes a terminal device 101, a printing device 102, and a Web server device 103. A user is capable of printing data generated by a Web application (an editing application described below) provided from the Web server device 103 using the printing device 102 via a printing application 302 described below. The terminal device 101 is an information processing apparatus, such as a smartphone, a personal computer (PC), a tablet terminal, a mobile phone, or a personal digital assistant (PDA).

The printing device 102 is a printer that adds recording agent, such as ink, on a recording medium, such as a sheet of paper, to print an image on the recording medium. The printing device 102 may be a multifunctional peripheral having multiple functions including a copy function, a facsimile (FAX) function, and a printing function. Although the printing device 102 is a device that performs printing using an inkjet method in the first embodiment, the printing device 102 is not limited to this mode. For example, the printing device 102 may be a device that performs printing using, for example, an electrophotographic method or a heat sublimation method.

The terminal device 101 communicates with the printing device 102 via a network built by an access point 100. Programs including the printing application 302 are stored in the terminal device 101. Accordingly, print data generated using the printing application 302 is transmitted from the terminal device 101 to the printing device 102 via the network. The access point 100 functions as, for example, a wireless local area network (LAN) router and the terminal device 101 is connected to the Internet via the wireless LAN router. Accordingly, the terminal device 101 is capable of communicating with the Web server device 103 for controlling the Web application via the Internet. Each of the terminal device 101 and the printing device 102 may be connected to the access point 100 via a wired LAN. The terminal device 101 and the printing device 102 may be connected to each other via the wired LAN.

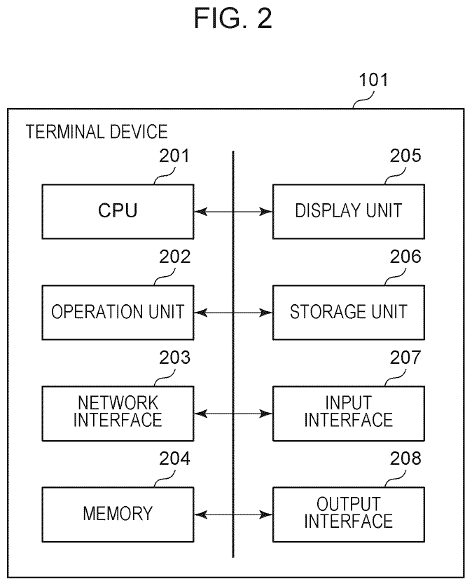

FIG. 2 illustrates the hardware configuration of the terminal device 101 of the first embodiment. The terminal device 101 includes a central processing unit (CPU) 201, an operation unit 202, a network interface 203, a memory 204, a display unit 205, a storage device 206, an input interface 207, and an output interface 208, which are connected to each other via a system bus.

The CPU 201 controls the entire terminal device 101.

The operation unit 202 is used by the user to issue an instruction to the terminal device 101 and includes, for example, buttons, a touch panel, and so on. Although the example is illustrated in FIG. 2, in which the operation unit 202 is incorporated in the terminal device 101, an external keyboard or the like may be connected to the input interface 207 and the terminal device 101 may be operated with the external keyboard.

The network interface 203 is an interface for connection to the network. The terminal device 101 is capable of being connected to the network via the network interface 203 and is capable of being connected to the Internet via the network.

The memory 204 is a random access memory (RAM) serving as a working area of the CPU 201 and a read only memory (ROM). The RAM is used as a temporary storage area of a variety of reception data and stores a variety of setting data. The ROM stores firmware and basic programs of the system.

The display unit 205 is a unit that displays a variety of information and is composed of, for example, a liquid crystal panel. Although the example is illustrated in FIG. 1, in which the display unit 205 is incorporated in the terminal device 101, an external display may be connected to the output interface 208 and the variety of information may be displayed in the external display. A touch panel display composed of the display unit 205 and the operation unit 202 may be provided.

The storage device 206 is, for example, a flash memory or the like. The storage device 206 stores applications including the printing application 302 described above, various control programs including an operating system (OS), and a variety of information used by the programs.

The input interface 207 is an interface for accepting data input by the user and an operation instruction from the user. The input interface 207 is composed of, for example, a physical keyboard, buttons, a touch panel, or the like. The output interface 208 described below and the input interface 207 may be integrated so that output of a screen and acceptance of an operation from the user are performed using common hardware.

The output interface 208 is an interface for controlling display of data and presentation of information about the state of the terminal device 101 in the external display or the like. The output interface 208 outputs, for example, control information and display target information used for displaying information in the external display. The external display includes a light emitting diode (LED), a liquid crystal display (LCD), and so on. The external display displays data and notifies the user of the state of the terminal device 101. A soft keyboard including numeric keys, a mode setting key, a determination key, a cancel key, a power key, and so on may be displayed on the external display and an input from the user may be accepted via the soft keyboard.

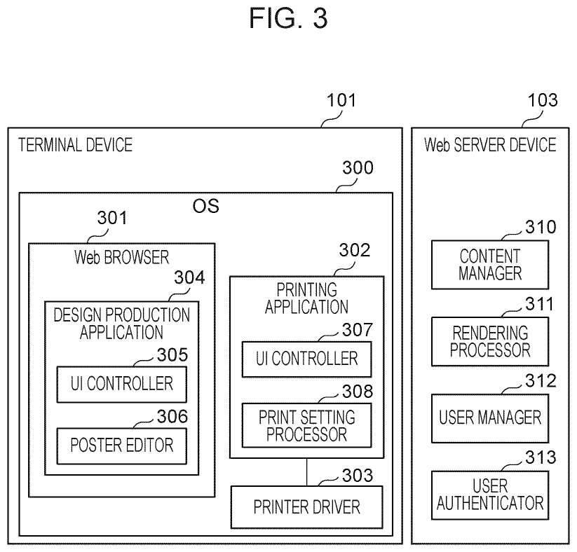

FIG. 3 illustrates an example of the functional configuration of the terminal device 101 and the Web server device 103. The terminal device 101 includes an OS 300. The OS 300 is, for example, Windows (registered trademark), macOS (registered trademark), Linux (registered trademark), iOS (registered trademark), or Android (registered trademark). The OS 300 includes a Web browser 301, the printing application 302, and a printer driver 303.

A design production application 304, which is the editing application in the first embodiment, is the Web application running on the Web browser 301. The user generates design data on the screen of the design production application 304. The design production application 304 includes a user interface (UI) controller 305 that controls a user's operation on the Web browser 301 and a poster editor 306 that performs an editing process of an image (a poster image or the like).

When data in the design production application 304 running on the Web browser 301 is to be permanently saved, the data is stored in a local storage of the Web browser 301. Although the local storage of the Web browser 301 is included in the storage device 206, the local storage of the Web browser 301 is capable of being accessed in the same browser and the same domain for security. Accordingly, another application (for example, the printing application 302) is not capable of accessing the local storage of the Web browser 301. In contrast, data in another application (for example, the printing application 302) is not capable of being acquired from the Web application. This is because the storage device 206, which is not a client-side storage, is not capable of being directly accessed from the Web application for security. The client-side storage means a local storage, a session storage, Cookie, and IndexedDB.

The design data generated by the design production application 304 may be posted in, for example, a home page, may be posted in a social network service (SNS), or may be printed with a printing device, which is connected to the terminal device 101. The user prints the design data generated by the design production application 304 on the screen of the printing application 302.

The printing application 302 is an application for performing printing based on print settings set by the user. The printing application 302 includes a UI controller 307 that controls a user's operation and a print setting processor 308 used to make the print settings. The printing application 302 is, for example, a native application that is associated with the design production application 304 and that is composed of programs capable of being directly executed on the OS. The printing application 302 is an application that causes the printing device 102 to print content data generated by the design production application 304. When the terminal device 101 is a PC, a process to generate the print data to be printed by the printing device 102 is performed by the printer driver 303. The printer driver 303 is distributed by a vendor of the printer and the user is capable of installing the printer driver 303 for usage. The printer driver 303 may be included in the OS.

The Web server device 103 includes a content manager 310, a rendering processor 311, a user manager 312, and a user authenticator 313. The content manager 310 manages content, such as image data, produced and edited by the design production application 304. The content manager 310 also manages template data to be supplied and downloaded content. The rendering processor 311 performs a rendering process to the content managed by the content manager 310. The user manager 312 manages user information for identifying the user. The user manager 312 is also capable of managing information associated with the user. The user authenticator 313 verifies the content of an authentication request to perform authentication of the user.

### Design Production Application

An example of a flow of a design production operation by the design production application 304 will now be described.

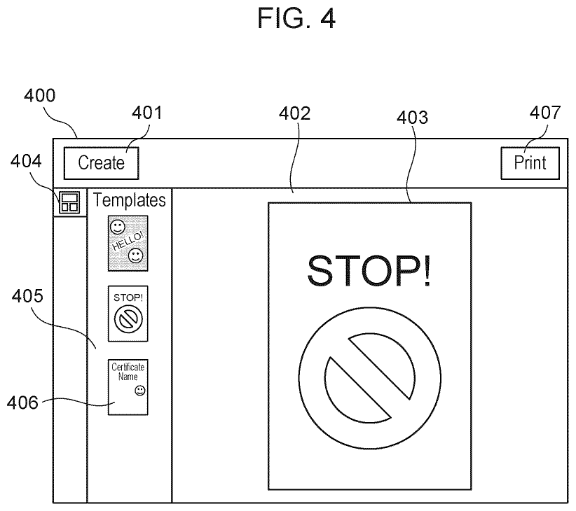

FIG. 4 illustrates an example of an editing screen for design data production, which is displayed in the display unit 205 upon execution of the program corresponding to the design production application 304 on the Web browser 301. An editing screen 400 is composed of a Create button 401, a design editing region 402, design data 403, a template list button 404, a selection item display region 405, one or multiple templates 406, and a Print button 407.

The design production application 304 displays new design data having no object arranged therein as the design data 403 in the design editing region 402 upon pressing (operation) of the Create button 401.

The design production application 304 displays the design data 403 in the design editing region 402.

The design production application 304 displays a list of templates in the selection item display region 405 upon pressing of the template list button 404. The one or multiple templates 406 provided by the design production application 304 are displayed in the list of templates. Although the example is described in which the design production application 304 provides the templates as a provision mode of the templates 406, the design production application 304 may acquire the templates 406 from the outside of the application via a server. Alternatively, the design production application 304 may share the template data generated by another user.

When an arbitrary template is selected, the selected template 406 may be displayed in the design editing region 402 as the design data 403 and the editing operation may be continuously performed.

The design production application 304 performs a starting process of the printing application 302 via the OS 300 upon pressing (operation) of the Print button 407. The starting process is a process to issue a starting instruction via the OS 300 using a custom Uniform Resource Locator (URL) scheme described below in a URL format, such as “printapp://”.

### Printing Application

An example of a flow of a print instruction operation by the printing application 302 will now be described.

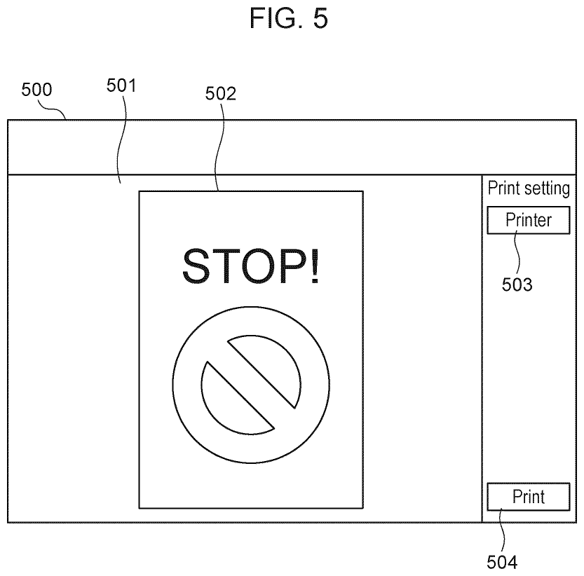

FIG. 5 illustrates an example of a print preview screen of the printing application 302. The printing application 302 is displayed in the display unit 205 upon execution of the program corresponding to the printing application 302, which is stored in, for example, the memory 204 or the storage device 206, by the CPU 201 in the terminal device 101, which has accepted the starting instruction from the design production application 304 via the OS 300. A print preview screen 500 is composed of a display region 501, print data 502, a Printer selection button 503, and a Print button 504.

The printing application 302 displays a thumbnail of the print data 502 generated by the rendering processor 311 from the design data 403 associated with the user authenticated by the user manager 312 in the display region 501.

The printing application 302 displays a list of printers that are connected upon pressing of the Printer selection button 503. The user is capable of selecting a desired printer from the list of printers. When the Print button 504 is pressed in the state in which the thumbnail of the print data 502 is displayed in the display region 501, the printing application 302 performs a print instruction to cause the printer selected with the Printer selection button 503 to print the print data.

The design production application 304, which is a starting source application, may start the printing application 302, which is a starting target application, using a method of the URL scheme. The URL scheme is information for accessing a specific resource. For example, (“http://”) is known as the URL scheme to access a Web page. For example, use of the URL scheme (“http://”) displays the Web browser. The URL scheme is capable of being uniquely defined by the application and is called the custom URL scheme. Use of the custom URL scheme enables the printing application 302 to be started from the design production application 304. Data is capable of being transferred between the applications by adding a value to the custom URL scheme.

For example, the printing application 302 accepts the starting instruction from the design production application 304 using the custom URL scheme via the OS 300. The program of an installer stores the custom URL scheme, such as “printapp://”, in the storage device 206 of the OS 300 in execution of the installer of the printing application 302 to register the custom URL scheme. The custom URL scheme may be registered at first start of the printing application 302. Upon execution of the custom URL scheme in the state in which the custom URL scheme is registered in the storage device 206, the OS 300 starts the application registered in association with the custom URL scheme. An authentication process of the user is performed at start of the printing application 302. The authentication may be performed by adding authentication information to the custom URL scheme at start of the printing application 302 or a login screen may be displayed on the printing application 302 at first start to perform the authentication process in response to an input by the user on the login screen.

If the printing application 302 is not installed in the information processing apparatus when the design production application 304, which is the Web application, starts the printing application 302 using the custom URL scheme, the design production application 304 is not capable of starting the printing application 302. However, the design production application 304 may not be capable of recognizing a status (state) of the printing application 302. For example, the design production application 304 may not be capable of determining whether the printing application 302 is downloaded and whether the printing application 302 is installed. This is because the storage area in which the native application (the printing application 302) is stored is not capable of being accessed by the Web application (the design production application 304) for security. Accordingly, since the design production application 304 may not be capable of performing the process corresponding to the status of the printing application 302, usability may be reduced. For example, there is a case in which the design production application 304 is not capable of appropriately notifying the user of the non-installation of the printing application 302 in the information processing apparatus and the usability may be reduced in this case.

Accordingly, in the first embodiment, information about the printing application 302, which is the native application, is stored in an appropriate storage area which the design production application 304, which is the Web application, is capable of accessing. The design production application 304, which is the starting source application, acquires the information about the printing application 302, which is the starting target application, to determine the status of the printing application 302. The design production application 304 performs an appropriate process based on the determined status of the printing application 302. For example, when it is determined that the printing application 302 is not downloaded, the design production application 304 notifies the user of information prompting download of the printing application 302. When it is determined that the printing application 302 is not installed, the design production application 304 notifies the user of information prompting installation of the printing application 302.

As a result, the design production application 304 is capable of performing the process corresponding to the status of the printing application 302 to improve the usability.

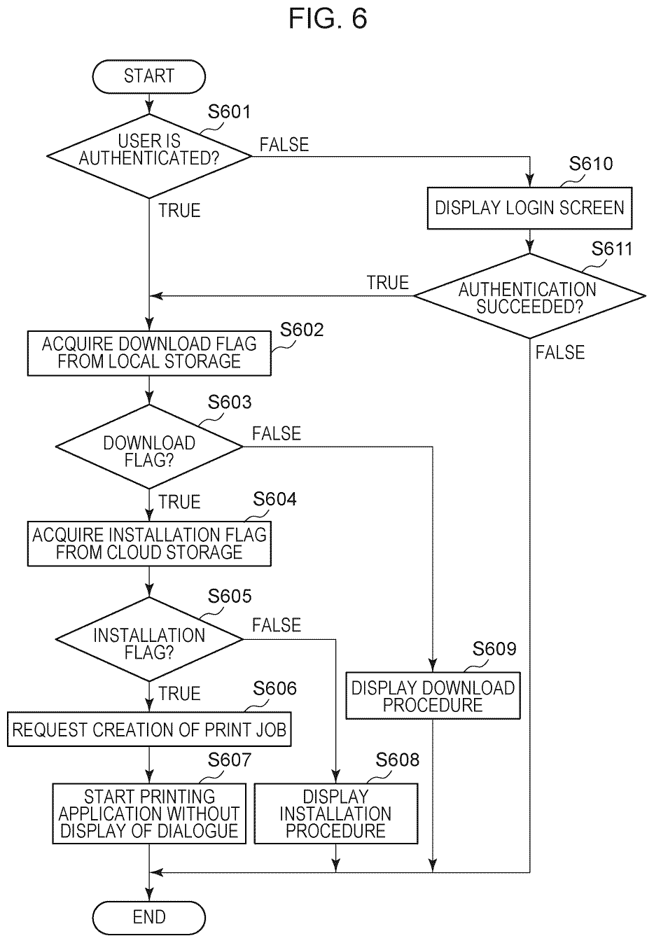

FIG. 6 is a flowchart when the printing application 302 is started from the design production application 304 via the OS 300.

Upon pressing of the Print button 407 on the editing screen 400 of the design production application 304, the process in the flowchart is started.

Referring to FIG. 6, in Step S601, the design production application 304 determines whether the user is authenticated. If the design production application 304 determines that the user is authenticated (TRUE in Step S601), the process goes to Step S602. If the design production application 304 determines that the user is not authenticated (FALSE in Step S601), the process goes to Step S610.

In Step S610, the design production application 304 displays the login screen (not illustrated).

In Step S611, the design production application 304 determines whether the authentication process succeeded on the login screen. If the design production application 304 determines that the authentication succeeded (TRUE in Step S611), the process goes back to Step S602. If the design production application 304 determines that the login screen is closed without a login process or that the authentication failed (FALSE in Step S611), the process in FIG. 6 is terminated and the editing screen 400 is displayed. In the display of the editing screen 400, the design production application 304 may display a region (dialogue) including information indicating that the authentication is not completed on the editing screen 400. The login screen may not be displayed after the Print button 407 is pressed. For example, when a Login button is provided on the editing screen 400, the design production application 304 displays the login screen on the editing screen 400 based on acceptance of an operation on the Login button to perform the user authentication. Step S601 may be performed after Step S603.

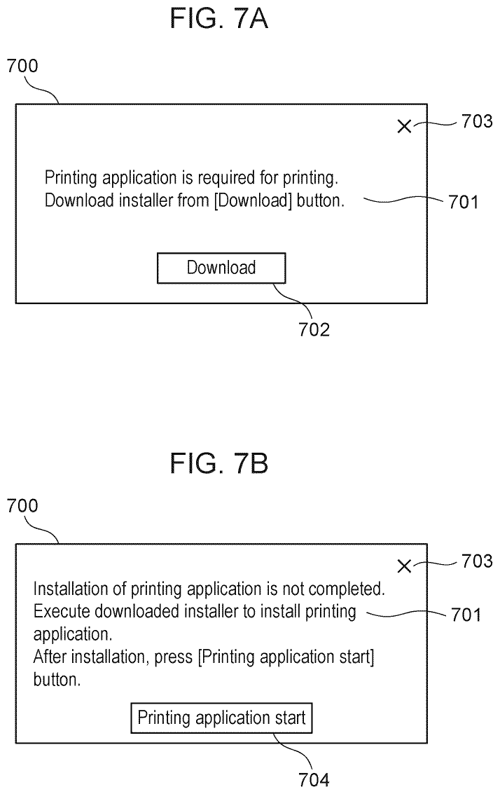

In Step S602, the design production application 304 acquires the value of a download button pressing flag (download flag) via the storage device 206 in the terminal device 101. The initial value of the download button pressing flag is “false”. Storage (saving) of the value of the download button pressing flag will be described below in Step S609 with reference to FIG. 7A.

In Step S603, the design production application 304 determines whether the value acquired in Step S602 indicates that the printing application 302 is downloaded. If the design production application 304 determines that the value acquired in Step S602 indicates that the printing application 302 is downloaded (TRUE in Step S603), the process goes to Step S604. If the design production application 304 determines that the value acquired in Step S602 indicates that the printing application 302 is not downloaded (FALSE in Step S603), the process goes to Step S609.

In Step S609, the design production application 304 displays a region (dialogue) including information indicating a download procedure of the printing application, illustrated in FIG. 7A. Then, the process in FIG. 6 is terminated. A dialogue 700 is composed of a message display region 701, a Download button 702, and a Close button 703. Information (a message) prompting download of the printing application is displayed in the message display region 701. Upon pressing of the Download button 702, the design production application 304 starts download of the installer of the printing application 302, which is in the content manager 310 in the Web server device 103. At this time, the design production application 304 sets the value of the download button pressing flag in the local storage of the Web browser 301, which is saved in the storage device 206, to “true”. Since the download button pressing flag is saved in the local storage of the Web browser 301, which is saved in the storage device 206, the download button pressing flag is associated with the information about the user who has logged in the terminal device 101. In addition, the download button pressing flag may be set to “true” when a download link is displayed or a download QR code (registered trademark) is displayed on the design production application 304 to perform the download with QR code reading software. Although the download button pressing flag may be saved in the Web server device 103, in which an installation flag described below is saved, the download button pressing flag is saved not in the Web server device 103 but in the local storage of the Web browser 301. If the user has downloaded and installed the printing application 302 in a first terminal device and the same user has logged in the design production application 304 in a second terminal device in a state in which the printing application 302 is not downloaded and is not installed when the download button pressing flag and the installation flag are saved in the Web server device 103, the design production application 304 may determine the second terminal device as the terminal device in which the printing application 302 is downloaded and installed. This is because the Web server device 103 manages the information indicating whether the printing application 302 is downloaded and installed in association with the user information and does not save the information indicating whether the printing application 302 is downloaded and installed in association with the terminal device. Accordingly, when the same user uses multiple terminal devices (for example, the same user uses different terminal devices in his/her office and his/her house), the user may not be notified of appropriate information.

Consequently, saving the download button pressing flag in the local storage of the Web browser 301 to associate the download button pressing flag with the terminal device causes, for example, the second terminal device described above to be determined to be FALSE in Step S603 and enables the user to be notified of the appropriate information. The design production application 304 closes the dialogue 700 upon pressing of the Close button 703.

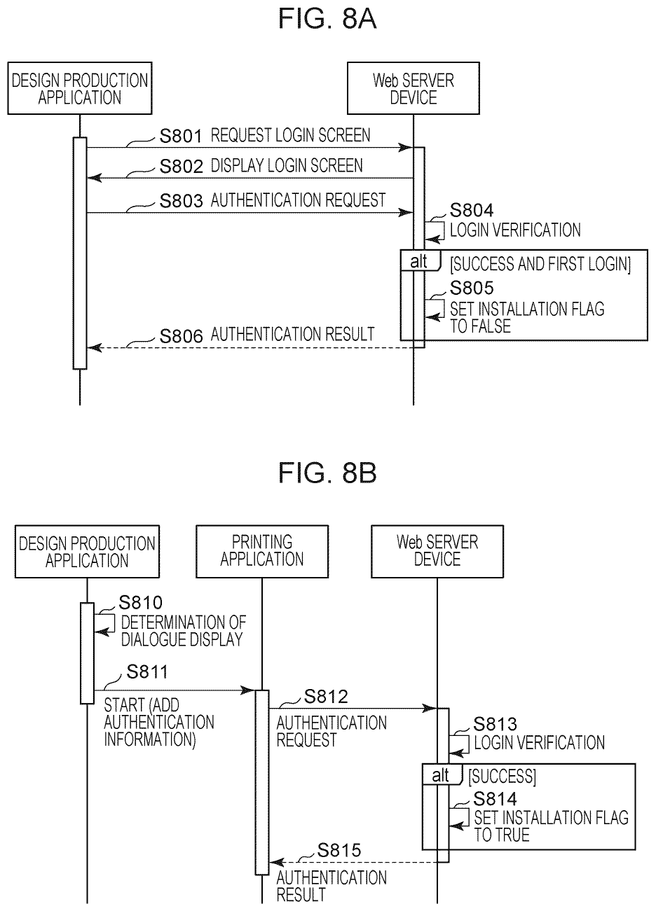

Referring back to the flowchart in FIG. 6, in Step S604, the design production application 304 acquires the value of the installation flag associated with the user information from the user manager 312 in the Web server device 103. Since the installation flag is saved in the Web server device 103, the installation flag is associated with the information about the user who has logged in the design production application 304. The initial value of the installation flag is “false”. The storage of the installation flag will be described below with reference to FIG. 8A and FIG. 8B. The determination of the installation, such as the installation flag, may be managed for each terminal device in association with the terminal device 101. Although the installation flag is saved in the storage device 206 when the installation flag is saved in association with the terminal device 101, the Web application (the design production application 304) is not capable of directly accessing the storage device 206, which is the memory other than the client-side storage of the Web browser 301, for security of the Web application, as described above. Accordingly, as an alternative, the installation flag is saved in the Web server device 103 which both the Web application and the native application are capable of accessing.

Referring back to the flowchart in FIG. 6, in Step S605, the design production application 304 determines whether the value acquired in Step S604 indicates that the printing application 302 is installed. If the design production application 304 determines that the value acquired in Step S604 indicates that the printing application 302 is installed (TRUE in Step S605), the process goes to Step S606. If the design production application 304 determines that the value acquired in Step S604 does not indicate that the printing application 302 is installed (FALSE in Step S605), the process goes to Step S608.

In Step S608, the design production application 304 displays a dialogue including information indicating an installation procedure of the printing application, illustrated in FIG. 7B. Then, the process in FIG. 6 is terminated. The dialogue 700 is composed of the message display region 701, the Close button 703, and a Printing application start button 704. Information (a message) prompting installation of the printing application is displayed in the message display region 701. Upon pressing of the Printing application start button 704, the design production application 304 starts Step S606 and the subsequent steps described below.

In Step S606, the design production application 304 requests the Web server device 103 to create a print job. Specifically, the design production application 304 instructs the rendering processor 311 in the Web server device 103 to perform the rendering process of the design data 403 on the editing screen 400.

In Step S607, the design production application 304 performs the starting process to start the printing application 302 via the OS 300 using the URL scheme without displaying the dialogues illustrated in FIG. 7A and FIG. 7B. Then, the process in FIG. 6 is terminated.

FIG. 8A and FIG. 8B are sequence diagrams concerning setting of the installation flag, including a user authentication process.

FIG. 8A is a diagram indicating a sequence to set the installation flag when the user authentication is performed in the design production application 304.

The process in the sequence in FIG. 8A is started, for example, upon pressing of the Print button 407 in a state in which the user authentication is not completed in the design production application 304.

Referring to FIG. 8A, in Step S801, the design production application 304 requests the login screen of the Web server device 103.

In Step S802, the Web server device 103 displays the login screen in the design production application 304.

In Step S803, the design production application 304 transmits the authentication request including an identifier (ID) and a password which the user has input on the login screen to the Web server device 103.

In Step S804, the Web server device 103 verifies the ID and the password received from the design production application 304 to perform login verification of whether the user is valid. If the verification succeeded in Step S804 and the user logs in for the first time, the sequence goes to Step S805. In Step S805, the Web server device 103 sets the installation flag to “false”, which is the initial value, in association with the user. The Web server device 103 determines that the user logs in for the first time in a state in which the installation flag associated with the user is not set in the user manager 312 in the Web server device 103.

If the verification succeeded in Step S804, in Step S806, the Web server device 103 starts a login session and adds an access right to the user who succeeded in login. If the verification failed in Step S804, in Step S806, the Web server device 103 returns an error message.

FIG. 8B is a diagram indicating a sequence to start the printing application 302 from the design production application 304 via the OS 300 to update the value of the installation flag.

The process in the sequence in FIG. 8B is started in the design production application 304 upon pressing of the Print button 407. The sequence in FIG. 8B supposes a case in which the authentication information is added from the design production application 304 in the state in which the printing application 302 is installed in the terminal device 101 and the printing application 302 is started via the OS 300 using the URL scheme.

Referring to FIG. 8B, in Step S810, the design production application 304 performs Step S601 to Step S611 in FIG. 6 in order to determine whether the starting instruction of the printing application 302 is to be issued. If the printing application 302 is installed, the design production application 304 performs Step S606 and Step S607 and the sequence goes to Step S811.

In Step S811, the design production application 304 issues the starting instruction of the printing application 302 via the OS 300 in a state in which the authentication information is added to a parameter of the URL scheme.

In Step S812, the printing application 302 submits the authentication request to the Web server device 103 based on the authentication information received in Step S811.

In Step S813, the Web server device 103 performs login authentication (verification) of whether the user is valid. If the authentication succeeded in Step S813, the sequence goes to Step S814. In Step S814, the Web server device 103 updates the installation flag to “true” in association with the user. The printing application 302 may add, for example, a universally unique identifier (UUID) of the terminal device 101 to the Web server device 103 in Step S812. The Web server device 103 may save the UUID of the terminal device 101 on the Web server device 103 in association with the user in Step S814.

If the authentication succeeded in Step S813, in Step S815, the Web server device 103 starts the login session and adds the access right to the user who succeeded in login. If the authentication failed in Step S813, in Step S815, the Web server device 103 returns an error message.

Then, upon pressing of the Print button 504 on the print preview screen 500, the printing application 302 transmits the print data to the printing device 102.

As described above, in the first embodiment, the information about the printing application 302, which is the native application, is stored in an appropriate storage area which the design production application 304, which is the Web application, is capable of accessing. The design production application 304, which the starting source application, acquires the information about the printing application 302, which is the starting target application, to determine the status of the printing application 302. The design production application 304 performs an appropriate process based on the determined status of the printing application 302. For example, when it is determined that the printing application 302 is not downloaded, the design production application 304 notifies the user of the information prompting download of the printing application 302. When it is determined that the printing application 302 is not installed, the design production application 304 notifies the user of the information prompting installation of the printing application 302.

Accordingly, the design production application 304 is capable of performing the process corresponding to the status of the printing application 302 to improve the usability.

### Second Embodiment

The configuration is described in the first embodiment, in which the design production application 304 is the Web application and the printing application 302 is the native application. In contrast, there is a case in which another native application is started from the native application.

In a second embodiment, a configuration is described in which both the design production application 304 and the printing application 302 are the native applications.

Since the second embodiment results from modification of the first embodiment, only the difference from the first embodiment is described in the second embodiment. The same reference numerals are added to portions corresponding to the first embodiment for description.

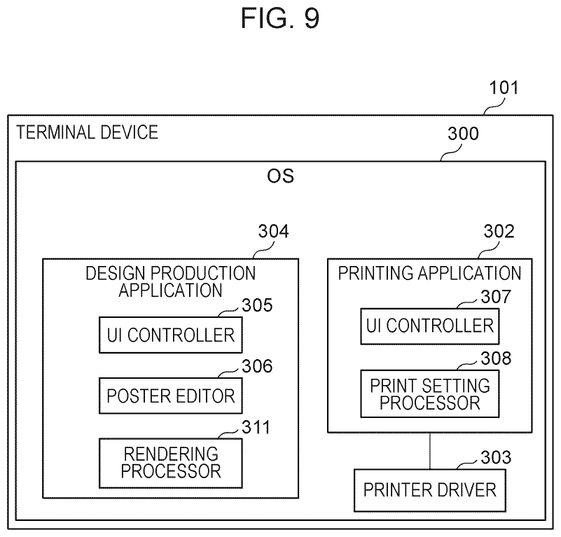

Since the diagram illustrating an example of the configuration of the print processing system and the diagram illustrating the hardware configuration of the terminal device 101 in the second embodiment are the same as those in FIG. 1 and FIG. 2 in the first embodiment, description of them is omitted herein. FIG. 9 is a block diagram illustrating the functional configuration of the terminal device 101 and the Web server device. Since FIG. 9 results from modification of FIG. 3, only the difference from FIG. 3 is described with reference to FIG. 9.

Although the design production application 304 is the Web application running on the Web browser 301 in FIG. 3, the design production application 304 is the native application in the second embodiment and the design production application 304 is provided in the OS 300. In addition, since the rendering processor 311 is provided in the design production application 304 in the second embodiment, the user authentication process is omitted and the Web server device 103 is not used in the configuration in the second embodiment.

When the data in the design production application 304 is to be permanently saved, the design production application 304 saves the data in the local storage of the Web browser 301 in FIG. 3 in the first embodiment. However, in the second embodiment, since the design production application 304 is capable of directly writing and referring to the data in the storage device 206, the data in the design production application 304 is saved in a storage area other than the local storage in the storage device 206.

When the starting process of the printing application 302 is performed from the design production application 304, the URL scheme may be used as in the first embodiment. However, an exe file may be executed in the design production application 304 to issue the starting instruction. When the exe file is executed to start the printing application 302, the starting process is performed via the OS 300. The user authentication process at start of the printing application 302 may be omitted in the second embodiment.

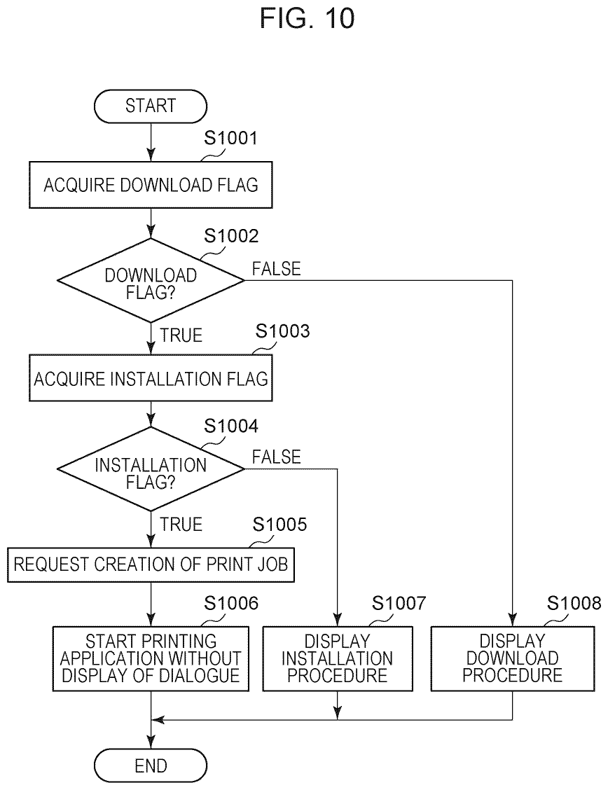

FIG. 10 is a flowchart when the printing application 302 is started from the design production application 304 via the OS 300 in the second embodiment. Since FIG. 10 is the flowchart resulting from modification of FIG. 6, only the difference from FIG. 6 is described here.

The process in the flowchart is started upon pressing of the Print button 407 on the editing screen 400 of the design production application 304.

Since the installation flag is not saved in the Web server device 103 in association with the user in the second embodiment, the user authentication process may be omitted. Accordingly, Step S601, Step S610 and Step S611 in FIG. 6 are omitted herein.

Referring to FIG. 10, in Step S1001, the design production application 304 acquires the value of the download button pressing flag from the storage device 206 in the terminal device 101. The storage of the value of the download button pressing flag is described below in Step S1008.

Since the determination process in Step S1002 is the same as in Step S603, description of Step S1002 is omitted herein. If the design production application 304 determines that the value acquired in Step S1001 indicates that the printing application 302 is downloaded (TRUE in Step S1002), the process goes to Step S1003. If the design production application 304 determines that the value acquired in Step S1001 does not indicate that the printing application 302 is downloaded (FALSE in Step S1002), the process goes to Step S1008. In Step S1008, the design production application 304 sets the value of the download button pressing flag to “true” in the storage device 206 upon pressing of the Download button 702 in FIG. 7A.

In Step S1003, the design production application 304 acquires the value of the installation flag from the storage device 206. The value of the installation flag is set to “true” in the storage device 206 at first start of the printing application 302.

Since the determination process in Step S1004 is the same as in Step S605, description of Step S1004 is omitted herein.

If the design production application 304 determines that the value acquired in Step S1003 indicates that the printing application 302 is installed (TRUE in Step S1004), the process goes to Step S1005. If the design production application 304 determines that the value acquired in Step S1003 does not indicate that the printing application 302 is installed (FALSE in Step S1004), the process goes to Step S1007. Since Step S1007 is the same as Step S608, description of Step S1007 is omitted herein.

Since Step S1005 is the same as Step S606, description of Step S1005 is omitted herein. However, in the second embodiment, the rendering processor 311 may be provided in the design production application 304 and the rendering process may be performed in the design production application 304 not via the Web server device 103. In addition, when the design production application 304 saves the print data after the rendering process in the storage device 206 and the print data is printed with the printing application 302, the printing application 302 may acquire the print data from the storage device 206.

In Step S1006, the design production application 304 starts the printing application 302 via the OS 300 using the URL scheme without displaying the dialogues illustrated in FIG. 7A and FIG. 7B. Then, the process in FIG. 10 is terminated.

As described above, in the second embodiment, in the collaborative operation of the native applications, the starting source application is capable of notifying the user of the information corresponding to the status of the starting target application to improve the usability.

It is possible to improve the usability in the collaborative operation of the multiple application programs.

### Other Embodiments

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-205845, filed Nov. 26, 2024, which is hereby incorporated by reference herein in its entirety.

What is claimed is:

1. A storage medium storing programs including a first application program and a second application program,
wherein the first application program causes a computer of an information processing apparatus to perform:
accepting an operation for starting the second application program;
acquiring first information indicating whether the second application program is downloaded in the information processing apparatus and second information indicating a state of the second application program; and
displaying information concerning the second application program, and
wherein, when the operation for starting the second application program is accepted, the displaying displays the information concerning the second application program based on at least one of the first information and the second information.

2. The storage medium storing programs according to claim 1,
wherein the first information is stored in a storage area which the first application program is capable of accessing and which the second application program is not capable of accessing.

3. The storage medium storing programs according to claim 1,
wherein the second information indicates whether the second application program is installed in the information processing apparatus.

4. The storage medium storing programs according to claim 1,
wherein, when the first information indicates that the second application program is not downloaded in the information processing apparatus, the displaying displays a region for prompting download of the second application program.

5. The storage medium storing programs according to claim 4,
wherein, when an operation is performed on the region for prompting download of the second application program, which is displayed by the first application program, the first information is stored as information indicating that the second application program is downloaded in the information processing apparatus.

6. The storage medium storing programs according to claim 1,
wherein, when the first information indicates that the second application program is downloaded in the information processing apparatus and the second information indicates that the second application program is not installed in the information processing apparatus, the displaying displays a region for prompting installation of the second application program.

7. The storage medium storing programs according to claim 1,
wherein, when the first information indicates that the second application program is downloaded in the information processing apparatus and the second information indicates that the second application program is installed in the information processing apparatus, the displaying does not display the information concerning the second application program and the first application program performs a process to start the second application program.

8. A control method of a first application program, the control method comprising:
accepting an operation for starting a second application program;
acquiring first information indicating whether the second application program is downloaded in an information processing apparatus and second information indicating a state of the second application program; and
displaying information concerning the second application program,
wherein, when the operation for starting the second application program is accepted, the displaying displays the information concerning the second application program based on at least one of the first information and the second information.

9. An information processing apparatus including a first application program, the information processing apparatus comprising:
an accepting unit configured to accept an operation for starting a second application program;
an acquiring unit configured to acquire first information indicating whether the second application program is downloaded in the information processing apparatus and second information indicating a state of the second application program; and
a display unit configured to display information concerning the second application program,
wherein, when the accepting unit accepts the operation for starting the second application program, the display unit displays the information concerning the second application program based on at least one of the first information and the second information.
